(19) United States
(12) Patent Application Publication
(10) Pub. No.: US 2018/0327561 A1
(43) Pub. Date: Nov. 15, 2018

(54) SURFACE-MODIFIED MATERIAL, COMPOSITION FOR SURFACE MODIFICATION, AND METHOD FOR RESTORATION

(71) Applicants: FUKUOKA UNIVERSITY, Fukuoka-shi, Fukuoka (JP); SUMITOMO CHEMICAL CAOMPANY, LIMITED, Chuo-ku, Tokyo (JP)

(72) Inventors: Shigeru YAO, Fukuoka-shi, Fukuoka (JP); Ryoko NAKANO, Fukuoka-shi, Fukuoka (JP)

(21) Appl. No.: 15/530,120

(22) PCT Filed: Jun. 5, 2015
(86) PCT No.: PCT/JP2015/066360

§ 371 Date: Dec. 5, 2016

(30) Foreign Application Priority Data
Jun. 5, 2014 (JP) 2014-116532

(51) Int. Cl. C08J 7/04; C08F 293/00; C09D 153/00; C09D 5/00

(52) U.S. Cl. CPC C08J 7/047; C08F 293/00; C08J 2451/06; C09D 5/00; C08J 2323/06; C09D 153/00

(57) ABSTRACT

A surface-modified material comprises a base material at least a portion of which is polyethylene; and polymer that modifies a surface of the polyethylene. The polymer is either of a block copolymer of monomers including first monomer that is (meth)acrylate having an alkane side chain with 10 or more carbon atoms in length, and second monomer that is (meth)acrylate containing tertiary amine, and block copolymer of monomers including first monomer that is (meth)acrylate having an alkane side chain with 10 or more carbon atoms in length, and second monomer that is (meth)acrylate having a side chain including —CF₂-structure having 4 or more carbon atoms.

### CROSS-REFERENCE TO RELATED APPLICATION

This international application claims the benefit of Japanese Patent Application No. 2014-116532 filed on Jun. 5, 2014 with the Japan Patent Office, the entire content of the Japanese Patent Application No. 2014-116532 is incorporated in this international application by reference.

### TECHNICAL FIELD

The present invention relates to a surface-modified material, composition for surface modification, and a method for restoration.

### BACKGROUND ART

Polyethylene is used in various fields. Polyethylene is weak in polarity and the surface thereof is hydrophobic. Thus, depending on the application, the surface of polyethylene needs to be modified. For the method of surface modification, a method is proposed in which the surface of polyethylene is treated with plasma (see Patent Document 1). On the other hand, if super water-repellency is required, a method is proposed in which such property is achieved by providing the surface with concave and convex shapes (see Patent Document 2).

### PRIOR ART DOCUMENTS

### Patent Documents

Patent Document 1: Japanese Unexamined Patent Application Publication No. 2011-012238

Patent Document 2: Japanese Unexamined Patent Application Publication No. 2003-236847

### SUMMARY OF THE INVENTION

### Problems to be Solved by the Invention

To implement the method according to Patent Document 1, a facility for plasma process that is a facility for high-voltage process is required. Moreover, to implement the method according to Patent Document 2, a process to accurately press the surface is required. In both cases, restoration to the original state is not possible when the surface-modified ethylene becomes unnecessary and should be recycled. In one aspect of the present invention, it is desirable to provide a surface-modified material, composition for surface modification, and a method for restoration for which manufacturing does not always require use of a large scale facility.

### Means for Solving the Problems

A surface-modified material according to one aspect of the present invention comprises a base material at least a portion of which is polyethylene, and polymer that modifies a surface of the polyethylene. The polymer is either of: block copolymer of monomers including first monomer that is (meth)acrylate having an alkane side chain with 10 or more carbon atoms in length, and second monomer that is (meth)acrylate containing tertiary amine; and block copolymer of monomers including first monomer that is (meth)acrylate having an alkane side chain with 10 or more carbon atoms in length, and second monomer that is (meth)acrylate having a side chain including —CF₂-structure having 4 or more carbon atoms.

The surface-modified material according to the present invention has various properties (for example, hydrophilicity, super water-repellency, adhesiveness, adsorptivity of metal ion (for example, iron ion), and so on) depending on the type of polymer (particularly the type of the second monomer) that modifies the surface of polyethylene. Moreover, manufacturing does not always require use of a large scale facility.

Composition for surface modification according to another aspect of the present invention comprises block copolymer of polymer including first monomer that is acrylate having an alkane side chain with 10 or more carbon atoms in length, and second monomer that is acrylate containing tertiary amine, or block copolymer of monomers including first monomer that is (meth)acrylate having an alkane side chain with 10 or more carbon atoms in length, and second monomer that is (meth)acrylate having a side chain including —CF₂-structure having 4 or more carbon atoms, and dispersion medium that disperses the block copolymer.

With the aforementioned composition for surface modification according to another aspect of the present invention, the surface of polyethylene can be modified, and various properties (for example, hydrophilicity, super water-repellency, adhesiveness, adsorptivity of metal ion (for example, iron ion) and so on) can be provided. Moreover, use of a large scale facility is not always necessary for surface modification of polyethylene. Moreover, when surface modification becomes unnecessary, the surface of the surface-modified material can be restored to the original state (unmodified state) (by a temperature-raising treatment, such as immersing the surface of the surface-modified material into warm water or warm solvent).

### BRIEF DESCRIPTION OF THE DRAWINGS

FIG. 1 is an explanatory view showing a structure of BHA-TBAEMA-based SCCBC:

FIG. 2 is an explanatory view illustrating principles in which BHA-TBAEMA-based SCCBC modifies a surface of a polyethylene film.

FIG. 3 is an explanatory view showing a structure of BHA-DEAEMA-based SCCBC.

FIG. 4 is an explanatory view showing a structure of BHA-HDFA-based SCCBC.

FIG. 5 is a photograph showing a surface-modified porous membrane before permeation of ink solution (left side) and a surface-modified porous membrane after permeation of ink solution (right side).

FIG. 6 is a chart showing a result of FT-IR analysis of BHA-DEAEMA-based SCCBC desorbed from a surface-modified porous membrane.

### EXPLANATION OF REFERENCE NUMERALS

101 . . . BHA-TBAEMA-based SCCBC, 103 . . . crystalline side chain, 105 . . . functional side chain, 107 . . . polyethylene film

### MODE FOR CARRYING OUT THE INVENTION

An embodiment of the present invention will be described. The surface-modified material according to the present invention comprises a base material and polymer. The base material is at least partially composed of polyethylene. The base material may be composed completely of polyethylene, or alternatively composed partially of polyethylene. The form of the base material is not particularly limited, and may be, for example, one of a film, a porous membrane, thread, hollow fiber, and a compound of these forms.

One portion or the entire portion of the surface of polyethylene is modified with polymer. The polymer is block copolymer of monomers including first monomer that is (meth)acrylate having an alkane side chain with 10 or more carbon atoms in length and second monomer that is acrylate containing tertiary amine, or block copolymer of monomers including first monomer that is (meth)acrylate having an alkane side chain with 10 or more carbon atoms in length and second monomer that is (meth)acrylate having a side chain including —CF₂-structure having 4 or more carbon atoms.

This block copolymer may be composed of the first monomer and the second monomer, and may further contain other monomers. In the present invention, the polymer may be, for example, a side chain crystalline block copolymer.

Polyethylene having the surface thereof modified with the block copolymers has various properties (for example, hydrophilicity, adhesiveness, the adsorptivity of metal ion (for example, iron ion), and so on) depending on the type of the block copolymer (particularly the type of the second monomer).

The first monomer may be one or more selected from a group consisting of, for example, behenyl acrylate (Behenyl Acrylate, BHA), stearyl acrylate (Stearyl Acrylate, STA), hexadecyl acrylate (Hexadecyl Acrylate, AHDA), and lauryl acrylate (Lauryl Acrylate, LA).

Moreover, the second monomer may be, for example, one or more selected from a group consisting of 2-(dimethyl amino)ethyl methacrylate (2-(Dimethylamino) ethyl Methacrylate, DMAEMA), 2-(dimethyl amino)ethyl acrylate (2-(Dimethylamino) ethyl Acrylate, DMAEA), 2-(dimethyl amino)ethyl methacrylate (2-(Diethylamino) ethyl Methacrylate, DEAEMA), 2-(dimethyl amino)ethyl acrylate (2-(Diethylamino) ethyl Acrylate, DEAEA), 2-(tert-butylamino)ethyl methacrylate (2-(tert-Butylamino) ethyl Methacrylate, TBAEMA), N, N-dimethylacrylamide (N, N-Dimethylacrylamide, DMAA), N, N-dimethyl aminopropyl acrylamide (N, N-Dimethylaminopropyl Acrylamide, DMAPAA), and N, N-diethylacrylamide (N, N-Diethylacrylamide, DEAA), and methacrylate or acrylate having a polar group, such as amide group and hydroxyl group, in the side chain portion. Alternatively, the second monomer may be one or more selected from a group consisting of 1H,1H,2H,2H-heptadecafluorodecyl acrylate (1H,1H,2H,2H-Heptadecafluorodecyl acrylate, HDFA), 2,2,3,3,4,4,5,5,6,6,7,7,-dodecafluorohepthyl acrylate (2,2,3,3,4,4,5,5,6,6,7,7-Dodecafluorohepthyl Acrylate, DDFA), and methacrylate or acrylate including the —CF₂-structure with carbon atoms at least 4 or more in the side chain portion.

The weight ratio of the first monomer and the second monomer contained in the polymer is preferably in the range of 1:0.2 to 20. With the weight ratio being within this range, the above-described properties become more prominent.

The composition for surface modification according to the present invention comprises a block copolymer of monomer containing the first monomer and the second monomer, and dispersion medium that disperses the block copolymer. The first monomer and the second monomer are the monomers described above. The block copolymer may be, for example, the side chain crystalline block copolymer.

The dispersion medium is not particularly limited and may be suitably selected from dispersion media that can disperse the block copolymer. The dispersion medium may be, for example, butyl acetate, C1 to C5 (carbon atoms 1 to 5) alcohols, acetone, C1 to C5 ketone, C1 to C5 ether, tetrahydrofuran, and so on.

The composition for surface modification according to the present invention can be used for modifying the surface of a base material (for example, a base material composed at least partially of polyethylene). The base material having the surface thereof modified with the composition for surface modification according to the present invention acquires various properties (for example, hydrophilicity, adhesiveness, adsorptivity of metal ion (for example, iron ion), and so on) depending on the type of the block copolymer (particularly the type of the second monomer).

Moreover, use of the composition for surface modification according to the present invention makes a base material unlikely to be physically damaged, which prevents the mechanical strength of the base material from being deteriorated and improves the durability of the base material.

Furthermore, for example, in the case of a porous membrane base material, use of the composition for surface modification according to the present invention facilitates modification inside pores of the porous membrane.

Moreover, the state of the base material can be easily restored to the original state by treatment in which a base material having the surface thereof modified with the surface modifying composition according to the present invention is, for example, immersed in warm water or warm temperature solvent.

When a substituent with adsorption ability of heavy metal and the like is introduced to a base material modified by a conventional method, rinsing with strong acid is required in order to desorb and dispose of the adsorbed heavy metal. However, when a base material having the surface modified with the composition for surface modification according to the present invention, the rinsing process with strong acid is not compulsory since, due to the treatment with warm water/warm solvent and the like, the composition for surface modification adsorbed heavy metal can be removed from the base material, which can remarkably reduce environmental burden.

The method for modifying the surface of a base material with the composition for surface modification according to the present invention may be, for example, a method in which composition for surface modification is attached to the surface of the base material by a dip method or a coating method, and then dispersion medium is evaporated.

The concentration of the block copolymers in the composition for surface modification may be, for example, 0.01 to 5% by weight. With the concentration being within this range, the above-described properties become more prominent.

### EMBODIMENT 1

1. Fabricating Composition for Surface Modification

4.8 g of behenyl acrylate, dispersed in 7.8 g of butyl acetate, was fed into a stirring polymertizer and then, while being heated in an oil bath (105° C.), polymerized under a nitrogen gas stream for 5 hours. At this time, the stirring speed of the stirring polymertizer was set to around 70 rpm.

Subsequently, 5.1 g of 2-(tert-butylamino) ethyl methacrylate, dispersed in 6.8 g of butyl acetate, was fed into the same stirring polymerizer, and then, while being heated in an oil bath (105° C.), polymerized under a nitrogen gas stream for 15 hours. The stirring speed of the stirring polymertizer at this time was also set to around 70 rpm.

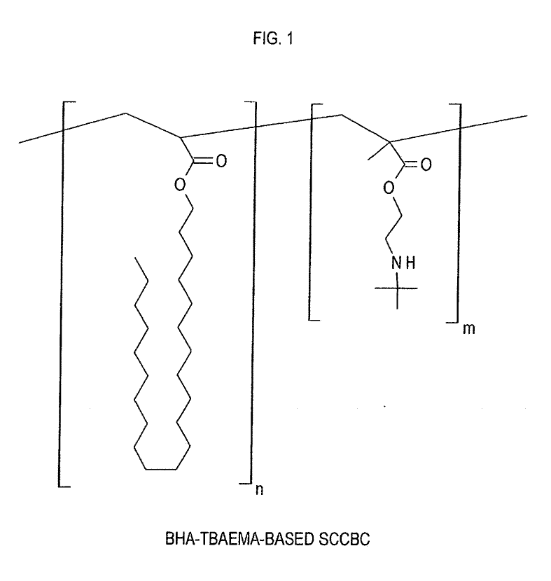

By the above-described process (living radical polymerization), polymer was fabricated. This polymer is a side chain crystalline block copolymer (Side Chain Crystalline Block Co-Polymer: SCCBC). Hereinafter, this polymer will be referred to as BHA-TBAEMA-based SCCBC. BHA-TBAEMA-based SCCBC has a structure shown in FIG. 1. In BHA-TBAEMA-based SCCBC, the weight ratio between behenyl acrylate and 2-(tert-butylamino) ethyl methacrylate is approximately 1:1.

BHA-TBAEMA-based SCCBC was dispersed in butyl acetate (one example of the dispersion medium) so that composition for surface modification 1A in which the concentration of BHA-TBAEMA-based SCCBC was 0.05 wt % and composition for surface modification 1B in which the concentration of BHA-TBAEMA-based SCCBC was 0.1 wt % were fabricated respectively.

2. Fabricating Surface-Modified Material

On the surface of a polyethylene film (one example of the base material), the composition for surface modification 1A was attached in accordance with the dip method. Subsequently, the dispersion medium was evaporated, and the surface of polyethylene film was modified with BHA-TBAEMA-based SCCBC. This surface-modified polyethylene film is one example of the surface-modified material, and will be referred to as a polyethylene film DA hereinafter.

On the surface of a polyethylene film, the composition for surface modification 1B was attached in accordance with the dip method. Subsequently, the dispersion medium was evaporated, and the surface of the polyethylene film was modified with BHA-TBAEMA-based SCCBC. This surface-modified polyethylene film is one example of the surface-modified material, and will be referred to as a polyethylene film DB hereinafter.

On the surface of a polyethylene film, the composition for surface modification 1A was coated with an applicator. Subsequently, the dispersion medium was evaporated, and the surface of the polyethylene film was modified with BHA-TBAEMA-based SCCBC. This surface-modified polyethylene film is one example of the surface-modified material, and will be referred to as a polyethylene film AA hereinafter.

On the surface of a polyethylene film, the composition for surface modification 1B was coated with an applicator. Subsequently, the dispersion medium was evaporated, and the surface of the polyethylene film was modified with BHA-TBAEMA-based SCCBC. This surface-modified polyethylene film is one example of the surface-modified material, and will be referred to as a polyethylene film AB hereinafter.

3. Evaluation for Surface-Modified Material

With regard to each of the polyethylene films DA, DB, AA, and AB, the contact angle of the surface was measured with a water contact angle measuring device. On the other hand, as a comparative example, the contact angle of the surface of a polyethylene film with an unmodified surface was measured in the same manner.

The result is shown in Table 1. In Table 1, “Concentration” shows the concentration in wt % of BHA-TBAEMA-based SCCBC contained in the used composition for surface modification. Moreover, “Modification Method” indicates the method for modifying the surface of the polyethylene film.

TABLE 1

| | Concentration | Modification | Contact |
|---|---|---|---|
| Surface-Modified Material | (wt %) | Method | Angle (°) |
| Polyethylene Film DA | 0.05 | Dip | 76.8 |
| Polyethylene Film DB | 0.1 | Dip | 72.4 |
| Polyethylene Film AA | 0.05 | Coating | 81.0 |
| Polyethylene Film AB | 0.1 | Coating | 74.4 |
| BHA-DEAEMA-based | 1 | Dip | 70.0 |
| SCCBC | | | |
| Comparative Example | — | — | 93.2 |

As shown in Table 1, with regard to each one of polyethylene films DA, DB, AA, and AB, the contact angle became smaller (became hydrophilic) as compared with the comparative example. Moreover, as the concentration wt % of the BHA-TBAEMA-based SCCBC in the composition for surface modification increases, the contact angle became further smaller.

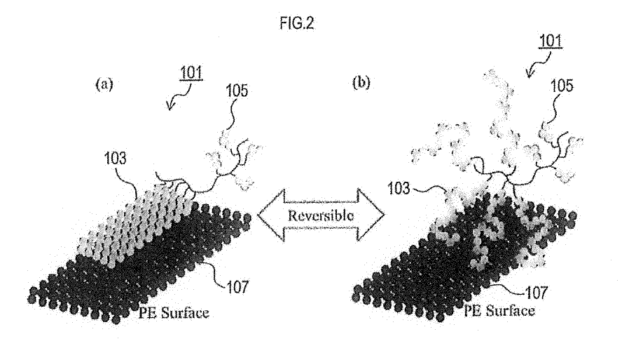

The reason for the surfaces of polyethylene films DA, DB, AA, and AB becoming hydrophilic can be speculated as follows. As shown in FIGS. 2(a) and 2(b), BHA-TBAEMA-based SCCBC 101 comprises a side chain (to be referred to as the crystalline side chain hereinafter) 103 composed of polymerized behenyl acrylate, and a side chain (to be referred to as functional side chain hereinafter) 105 composed of polymerized 2-(tert-butylamino) ethyl methacrylate. As shown in FIG. 2(a), the crystalline side chains 103 adsorb onto the surface of the polyethylene film (PE) 107 whereas the functional side chains 105 cover the surface of the polyethylene film 107. As a result, depending on the properties of the functional side chains 105, the surfaces of the polyethylene films DA, DB, AA, and AB are modified. Moreover, as shown in FIG. 2(b), BHA-TBAEMA-based SCCBC 101 is reversibly adsorbed to/desorbed from the surface of the polyethylene film 107.

### EMBODIMENT 2

1. Fabricating Composition for Surface Modification

5.0 g of behenyl acrylate, dispersed in 7.7 g of butyl acetate, was fed in a stirring polymertizer, and then, while being heated in an oil bath (105° C.), polymerized under a nitrogen gas stream for 5 hours. At this time, the stirring speed of the stirring polymertizer was set to around 70 rpm.

Subsequently, 4.2 g of 2-(dimethylamino) ethyl methacrylate, dispersed in 4.1 g of butyl acetate, was fed into the same stirring polymerizer, and then, while being heated in an oil bath (105° C.), polymerized under a nitrogen gas stream for 15 hours. The stirring speed of the stirring polymertizer at this time was also set to around 70 rpm.

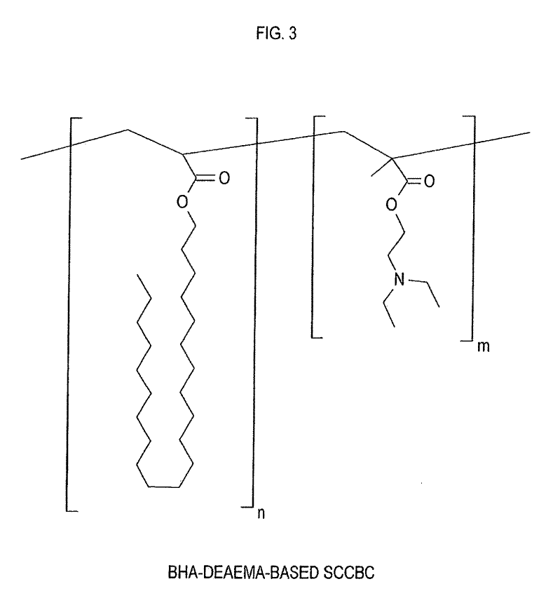

By the above described process (living radical polymerization), polymer was fabricated. This polymer is a side chain crystalline block copolymer (Side Chain Crystalline Block Co-Polymer: SCCBC). Hereinafter, this polymer will be referred to as BHA-DEAEMA-based SCCBC. BHA-DEAEMA-based SCCBC has the structure shown in FIG. 3.

BHA-DEAEMA-based SCCBC was dispersed in butyl acetate (one example of the dispersion medium) so that composition for surface modification 1C in which the concentration of BHA-DEAEMA-based SCCBC was 1 wt % was fabricated.

2. Fabricating Surface-Modified Material

A porous polyethylene membrane (one example of the base material) was prepared. This porous polyethylene membrane is a UPE (Ultra High Molecular Weight Polyethylene) disc filter manufactured by Nihon Entegris K.K. and having a diameter of 47 mm. The diameter of particle removing pores is 0.1 μm. Moreover, the surface of this porous polyethylene membrane is hydrophobic.

The porous polyethylene membrane was immersed into the composition for surface modification 1C for 18 hours. Subsequently, the porous polyethylene membrane was taken out and dried. By the above-described processes, the surface of the porous polyethylene membrane was modified with BHA-DEAEMA-based SCCBC. The porous polyethylene membrane having the surface thereof modified (to be referred to as surface-modified porous membrane hereinafter) is one example of the surface-modified material.

3. Evaluation for Surface-Modified Material

### (1) Evaluation for Hydrophilicity

A surface-modified porous membrane was placed in a membrane filter holder. Subsequently, water solution of blue-black ink (to be simply referred to as ink solution hereinafter) containing iron ion was poured from the upper portion of the membrane filter holder. The same process was performed, as a comparative example, with regards to a porous polyethylene membrane with an unmodified surface.

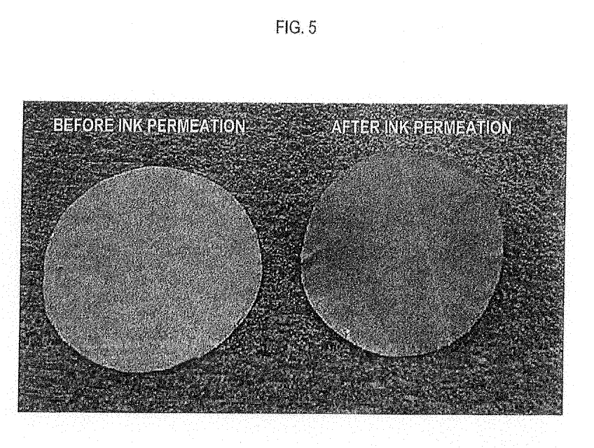

The surface-modified porous membrane allowed the permeation of the ink solution. This indicates that the surface of the surface-modified porous membrane was modified to be hydrophilic. Moreover, as shown in the right side of FIG. 5, the surface-modified porous membrane after the permeation of the ink solution was colored. The left side of FIG. 5 shows the surface unmodified porous membrane before the permeation of the ink solution. This surface unmodified porous membrane was not colored by the ink solution.

The porous polyethylene membrane with the unmodified surface, did not allow the permeation of the ink solution. This is due to the hydrophobicity of the unmodified surface of the porous polyethylene membrane.

Furthermore, the contact angle was measured with regard to BHA-DEAEMA-based SCCBC in the same manner as in the above-described Embodiment 1. The result is presented in Table 1 shown above.

### (2) Evaluation for Properties to Adsorb Iron Ion

Similarly in the above-described (1), BHA-DEAEMA-based SCCBC was desorbed from the surface-modified porous membrane after the permeation of the ink solution into methanol solvent and concentrated by reflux flow under the temperature condition of 80° C. Then, FT-IR analysis was performed with regard to the solid obtained by the concentration to remove the solvent. Moreover, the same process was performed, as a comparative example, with regard also to the surface unmodified porous membrane that did not allow the permeation of the ink solution.

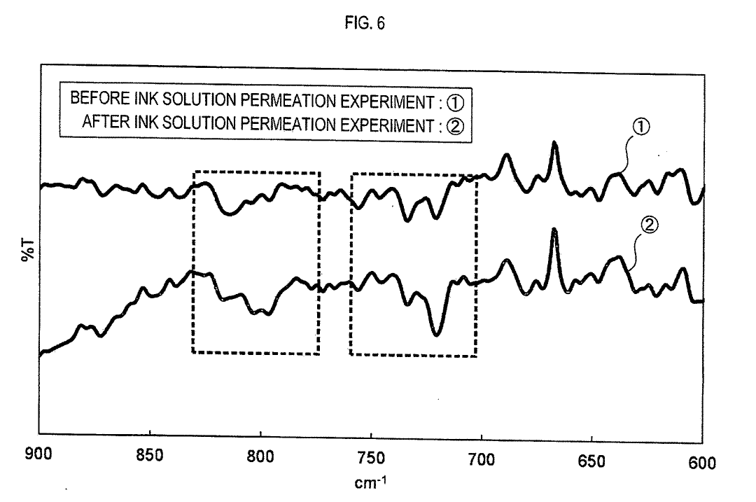

FIG. 6 shows the result of the FT-IR analysis. In the case of the surface-modified porous membrane after the permeation of the ink solution, the peak of absorption of iron ion (in the vicinity of 700 cm⁻¹ and 800 cm⁻¹) was confirmed, whereas in the case of the surface unmodified porous membrane that did not allow the permeation of the ink solution, the peak of absorption of iron ion was not confirmed. These results indicate that the surface-modified porous membrane has properties to adsorb iron ion. Accordingly, the surface-modified porous membrane can be used as an adsorbent for metal ions, such as iron ion.

As described above, BHA-DEAEMA-based SCCBC is desorbed from a porous polyethylene membrane simply by raising the environmental temperature (for example, by contacting with warm water, heated methanol, and so on). Other SCCBC, apart from BHA-DEAEMA-based SCCBC (for example, BHA-TBAEMA-based SCCBC and the like), also have the same properties.

Accordingly, for example, metal ion is adsorbed by SCCBC that modifies the surface of a porous polyethylene membrane, and then the SCCBC that has absorbed metal ion can be easily desorbed from the porous polyethylene membrane by raising the environmental temperature.

Conventional metal ion adsorbent requires to use strong acid to desorb adsorbed metal ion, whereas with SCCBC, desorbing with strong acid is not always necessary.

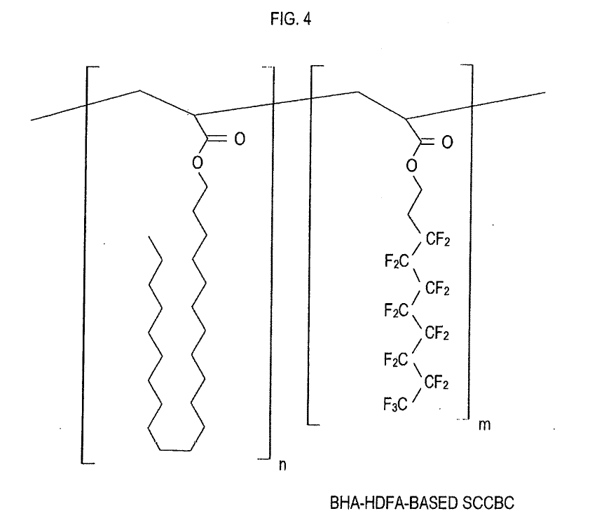

Moreover, in the above-described Embodiment 1 or Embodiment 2, polymer having the structure shown in FIG. 4 may be used. This polymer is BHA-HDFA-based SCCBC which is a side chain crystalline block copolymer.

What is claimed is:

1-7. (canceled)

8. A surface-modified material comprising:
a base material at least a portion of which is polyethylene; and
polymer that modifies a surface of the polyethylene,
wherein the polymer is either of:
block copolymer of monomers including first monomer that is (meth)acrylate having an alkane side chain with 10 or more carbon atoms in length, and second monomer that is (meth)acrylate containing tertiary amine, and
block copolymer of monomers including first monomer that is (meth)acrylate having an alkane side chain with 10 or more carbon atoms in length, and second monomer that is (meth)acrylate having a side chain including —CF₂-structure having 4 or more carbon atoms.

9. The surface-modified material according to claim 8, wherein the polymer is a side chain crystalline block copolymer.

10. The surface-modified material according to claim 8, wherein the first monomer is one or more selected from a group consisting of behenyl acrylate, stearyl acrylate, hexadecyl acrylate, and lauryl acrylate.

11. The surface-modified material according to claim 8, wherein the second monomer is either one of:
one or more selected from a group consisting of 2-(dimethylamino)ethyl methacrylate, 2-(dimethylamino)ethyl acrylate, 2-(dimethylamino)ethyl methacrylate, 2-(dimethylamino)ethyl acrylate, 2-(tert-butylamino)ethyl methacrylate, N, N-dimethylacrylamide, N, N-dimethyl aminopropyl acrylamide, and N, N-diethylacrylamide, and methacrylate or acrylate having a polar group in the side chain portion; and
one or more selected from a group consisting of 1H,1H,2H,2H-heptadecafluorodecyl acrylate, 2,2,3,3,4,4,5,5,6,6,7,7,-dodecafluorohepthyl acrylate, and methacrylate or acrylate including the —CF₂-structure with carbon atoms at least 4 or more in the side chain portion.

12. The surface-modified material according to claim 11, wherein the polar group is one of amide group and hydroxyl group.

13. The surface-modified material according to claim 8, wherein the base material is one of a film, a porous membrane, thread, and hollow fiber.

14. A surface-modified material comprising:
one of block copolymer (A) of monomers including first monomer that is (meth)acrylate having an alkane side chain with 10 or more carbon atoms in length, and second monomer that is (meth)acrylate containing tertiary amine, and block copolymer (B) of monomers including first monomer that is (meth)acrylate having an alkane side chain with 10 or more carbon atoms in length, and second monomer that is (meth)acrylate having a side chain including —CF₂-structure having 4 or more carbon atoms; and
dispersion medium that disperses one of the block copolymer (A) and the block copolymer (B).

15. A composition for surface modification according to claim 14 comprising:
block copolymer of polymer including first monomer that is acrylate having an alkane side chain with 10 or more carbon atoms in length, and second monomer that is acrylate containing tertiary amine; and
dispersion medium that disperses the one of the block copolymer (A) and the block copolymer (B).

16. A method for restoring a state of a surface of the surface-modified material according to claim 8, wherein the surface is restored to an unmodified state by immersing the surface modified materials into either one of warm water and warm solvent.

17. A method for manufacturing the surface-modified material according to claim 8 comprising:
attaching the composition for surface modification according to claim 14 to the surface of the base material at least partially composed of polyethylene; and
evaporating the dispersion medium attached to the base material.
